(19) United States
(12) Patent Application Publication
(10) Pub. No.: US 2024/0357489 A1
(43) Pub. Date: Oct. 24, 2024

(54) Electronic Devices with Proactive Cellular Connection Management

(71) Applicant: Apple Inc., Cupertino, CA (US)

(72) Inventors: Nabil Akdim, Munich (DE); Jayanth Rai, Munich (DE); Gencer Cili, San Jose, CA (US); Thorsten Clevorn, Munich (DE); Sethuraman Gurumoorthy, San Ramon, CA (US); Srirang A. Lovlekar, Fremont, CA (US); Vijay Venkataraman, San Jose, CA (US)

(21) Appl. No.: 18/305,218

(22) Filed: Apr. 21, 2023

(51) Int. Cl. H04W 52/02; H04W 76/11

(52) U.S. Cl. CPC H04W 52/0212; H04W 52/0229; H04W 76/11

(57) ABSTRACT

A communications system may include a data collection server (DCS) that receives contextual information from a set of UE devices. The DCS may aggregate the contextual information into a database. A given UE may proactively identify an optimal network configuration to use in communicating with a cellular network. The UE may generate local contextual information. The UE may request a set of entries from the database corresponding to a set of geographic tiles overlapping or neighboring its location. The UE may select the optimal network configuration based on its local contextual information and the requested entries. The UE may transmit a request to a base station to perform communications under the optimal network configuration using user equipment assistance information (UAI) of a radio resource control (RRC) signal. Proactive selection of the network configuration may optimize performance given the current UE operating context without requiring reactive network configuration adjustments.

### FIELD

This disclosure relates generally to wireless communications, including wireless communications performed by user equipment devices.

### BACKGROUND

Communications systems often include user equipment devices that convey wireless data with a network. The network establishes a wireless connection with the user equipment device that implements a network configuration. The network sets the network configuration under the assumption of a worse-case scenario with respect to radio conditions and extreme key performance indicator values of interest, consuming as many resources as possible to help ensure that the wireless connection and data transmission are successfully established and maintained.

The user equipment can perform reactive adjustments to the network configuration to downgrade the configuration after the user equipment begins to overheat. However, reactive adjustments can consume excessive power and can cause disruptions to wireless communication.

### SUMMARY

A communications system may include user equipment (UE) devices that communicate with a network such as a cellular network having wireless base stations. The system may include a data collection server (DCS). The DCS may receive contextual information from a set of UE devices. The contextual information may include application information (e.g., application usage type), network configuration settings (e.g., network operator), wireless performance metric data, and location information. The DCS may aggregate the contextual information into a database. Each entry of the database may identify a preferred network configuration for each combination of location, application usage type, and operator from the contextual information received from the set of UE devices.

A given UE device may proactively identify an optimal network configuration to use in communicating with the cellular network. The UE device may generate local contextual information. The local contextual information may include an application list, cellular metrics, battery information, power information, location information, and/or other parameters. The UE device may request a set of entries from the database on the DCS corresponding to a set of geographic tiles. The set of geographic tiles may overlap or neighbor the current and/or future expected future location of the UE device. The DCS may transmit the requested entries to the UE device. The UE device may select the optimal network configuration based on its local contextual information and the requested entries. For example, the UE device may select the network configuration specified by the entry corresponding to its current location, operator, and application usage type that also satisfies its current power and battery constraints.

The UE device may transmit a request to a base station to perform communications using the optimal network configuration. The UE device may transmit the request using user equipment assistance information (UAI) of a radio resource control (RRC) signal, for example. The base station may transmit an RRC response to the UE device accepting some or all of the request. The UE device and the base station may thereafter perform wireless communications using the optimal network configuration. In this way, the UE device may proactively determine a network configuration that optimizes performance given its current or expected operating context, without requiring reactive adjustments to the network configuration that would otherwise waste power or disrupt communications. Alternatively, the UE device may maximize privacy by only considering locally generated information in selecting the optimal network configuration.

An aspect of the disclosure provides a method of operating a user equipment device. The method can include receiving, at a receiver, network configuration data aggregated from a set of additional user equipment devices. The method can include transmitting, using one or more antennas, a request to a wireless base station to perform wireless communications using a network configuration that is selected based on the network configuration data aggregated from the set of additional devices.

An aspect of the disclosure provides a method of operating a server. The method can include receiving, at a receiver, contextual information from a set of user equipment devices, the contextual information identifying locations and application data transmission patterns of the user equipment devices in the set of user equipment devices. The method can include aggregating, using one or more processors, the contextual information into entries of a data structure, each entry of the data structure identifying a network configuration exhibiting peak aggregate wireless performance for a different respective combination of the locations and the application data transmission patterns. The method can include receiving, at the receiver, a request from a given user equipment device for a set of entries from the data structure. The method can include transmitting, using a transmitter, the set of entries from the data structure to the given user equipment device.

An aspect of the disclosure provides an electronic device. The electronic device can include one or more processors configured to execute an application that requires conveying wireless data. The electronic device can include a radio configured to convey the wireless data at a geographic location using a set of different network configurations, the radio being further configured to gather wireless performance metric data associated with the wireless data conveyed by the radio. The electronic device can include one or more antennas. The one or more antennas can be configured to transmit a radio resource control (RRC) signal to a wireless base station, the RRC signal including a user equipment assistance information (UAI) message identifying a network configuration that is selected from the set of different network configurations based on the wireless performance metric data. The one or more antennas can be configured to convey the wireless data with the wireless base station using the identified network configuration while the electronic device is at the geographic location.

### BRIEF DESCRIPTION OF THE DRAWINGS

FIG. 1 is a diagram of an illustrative communications system having user equipment devices that communicate with a network in accordance with some embodiments.

FIG. 2 is a schematic block diagram of an illustrative user equipment device in accordance with some embodiments.

FIG. 3 is a diagram showing how an illustrative user equipment device may move through a geographic region divided into tiles in accordance with some embodiments.

FIG. 4 is a diagram showing how an illustrative user equipment device may request an optimal network configuration from a wireless base station based on network configuration information aggregated at a data collection server from a set of other UE devices in accordance with some embodiments.

FIG. 5 is a diagram of an illustrative network configuration database that may be aggregated at a data collection server from a set of UE devices in accordance with some embodiments.

FIG. 6 is a diagram of an illustrative application usage type database that may be stored at a data collection server in accordance with some embodiments.

FIG. 7 is a flow chart of illustrative operations involved in performing wireless communications using a user equipment device that requests an optimal network configuration from a wireless base station based on network configuration information aggregated at a data collection server from a set of other UE devices in accordance with some embodiments.

FIG. 8 is a flow chart of illustrative operations that may be performed by a user equipment device to download information from a data collection server for use in identifying an optimal network configuration in accordance with some embodiments.

FIG. 9 is a diagram showing one example of how an illustrative user equipment device may request a maximum network configuration beyond an optimal network configuration in accordance with some embodiments.

FIG. 10 is a plot showing how an illustrative user equipment device may optimize wireless performance by proactively requesting a network configuration using the systems and methods described herein in accordance with some embodiments.

### DETAILED DESCRIPTION

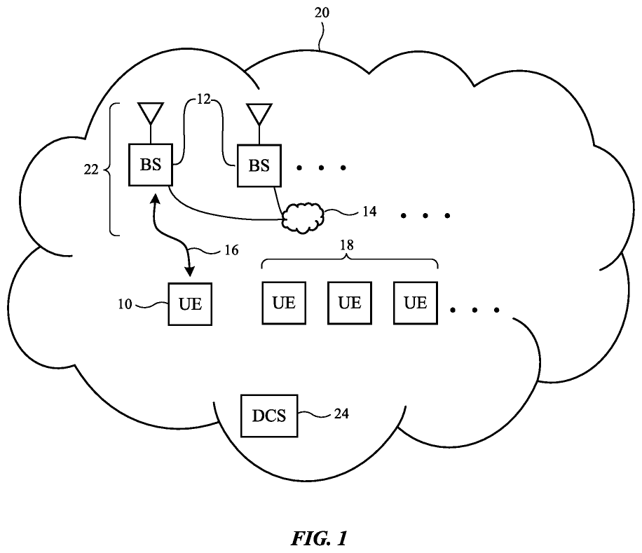

FIG. 1 is a schematic diagram of an illustrative communications system 20 (sometimes referred to herein as communications network 20) for conveying wireless data between communications terminals. Communications system 20 may include network nodes (e.g., communications terminals). The network nodes may include user equipment (UE) such as one or more UE devices 10. The network nodes may also include external communications equipment (e.g., communications equipment other than UE devices 10) such as external communications equipment 12. External communications equipment 12 may include wireless base stations, wireless access points, or other wireless equipment for example. Implementations in which external communications equipment 12 is a wireless base station (BS) that supports cellular telephone communications (e.g., voice and/or data signals) are described herein as an example. External communications equipment 12 may therefore sometimes be referred to herein as wireless base station 12, gNB 12, or simply as base station 12. UE devices 10 and base station 12 may communicate with each other using wireless communications links. If desired, UE devices 10 may wirelessly communicate with base station 12 without passing communications through any other intervening network nodes in communications system 20 (e.g., UE devices 10 may communicate directly with base station 12 over-the-air).

Communications system 20 may form a part of a larger communications network that includes network nodes coupled to base station 12 via wired and/or wireless links. The larger communications network may include one or more wired communications links (e.g., communications links formed using cabling such as ethernet cables, radio-frequency cables such as coaxial cables or other transmission lines, optical fibers or other optical cables, etc.), one or more wireless communications links (e.g., short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles, etc.), communications gateways, wireless access points, base stations, switches, routers, servers, modems, repeaters, telephone lines, network cards, line cards, portals, user equipment (e.g., computing devices, mobile devices, etc.), etc. The larger communications network may include communications (network) nodes or terminals coupled together using these components or other components (e.g., some or all of a mesh network, relay network, ring network, local area network, wireless local area network, personal area network, cloud network, star network, tree network, or networks of communications nodes having other network topologies), the Internet, combinations of these, etc. UE devices 10 may send data to and/or may receive data from other nodes or terminals in the larger communications network via base stations 12 (e.g., base stations 12 may serve as an interface between UE devices 10 and the rest of the larger communications network).

Some or all of the communications network may, if desired, be operated by a corresponding network operator or service provider. For example, communication system 20 may include a core network (CN) 14 operated by a network operator or service provider. Core network 14 may include end hosts, terminals, network nodes, servers, switches, routers, local area networks, distributed networks, the Internet, or any desired network topology. Core network 14 may control the forwarding of data from UE device 10 to other end hosts of system 20. Core network 14 may control the operation of base stations 12, may serve wireless data for transmission to UE devices 10, may receive wireless data from UE devices 10 (via base stations 12), etc. Core network 14 may be operated by the network operator or service provider of base stations 12 (sometimes referred to herein simply as an “operator”), by a service provider associated with the operating system and/or manufacturer of one or more UE devices 10, or may be any other desired network or sub-network within communications system 20. Core network 14 and base stations 12 may sometimes be referred to collectively herein as network 22 (or simply as “the network”).

Base station 12 may include one or more antennas (e.g., antennas arranged in one or more phased antenna arrays for conveying signals at frequencies greater than 10 GHz or other antennas for conveying signals at lower frequencies) that provides wireless coverage for UE devices 10 located within a corresponding geographic area or region, sometimes referred to as a cell. The size of the cell may correspond to the maximum transmit power level of base station 12 and the over-the-air attenuation characteristics for radio-frequency signals conveyed by base station 12, for example. When a UE device 10 is located within the cell, the UE device may connect with base station 12 (sometimes referred to herein as attaching to base station 12) and may then communicate with base station 12 over a wireless link. To support the wireless link, base station 12 may transmit radio-frequency signals in a downlink (DL) direction from base station 12 to the UE device and/or the UE device may transmit radio-frequency signals in an uplink (UL) direction from the UE device to base station 12 (e.g., the wireless links may be bidirectional links).

In the example of FIG. 1, a given UE device 10 may be located in the vicinity of a given base station 12 (e.g., within the cell of base station 12). UE device 10 may therefore communicate with base station 12 over a corresponding wireless link (sometimes referred to herein as a communications link or wireless connection). Radio-frequency signals 16 (e.g., cellular signals) may be conveyed between UE device 10 and base station 12 to support the wireless link. There may also be a set 18 of other UE devices 10 in communications system 20. Set 18 may include UE devices that also communicate with/via network 22 (over respective wireless connections) and/or may include UE devices that are in the same or a different geographic area, vicinity, location, city, state, country, or region as UE device 10, for example.

System 20 may also include one or more data collection servers such as data collection server (DCS) 24. DCS 24 may include a receiver that receives contextual information (data) from UE devices in system 20 (e.g., directly, via network 22, via other network nodes, etc.). DCS 24 may aggregate the contextual information received from UE devices. DCS 24 may provide some of the aggregated information to UE device 10. UE device 10 may use the aggregated information to identify an optimal network configuration for UE device 10 to use in communicating with a base station 12, for example. While referred to herein as a server, DCS 24 may be implemented or distributed across one or more underlying physical devices or network nodes (e.g., as a logical networking entity distributed across one or more underlying physical entities, as a cloud computing region, etc.).

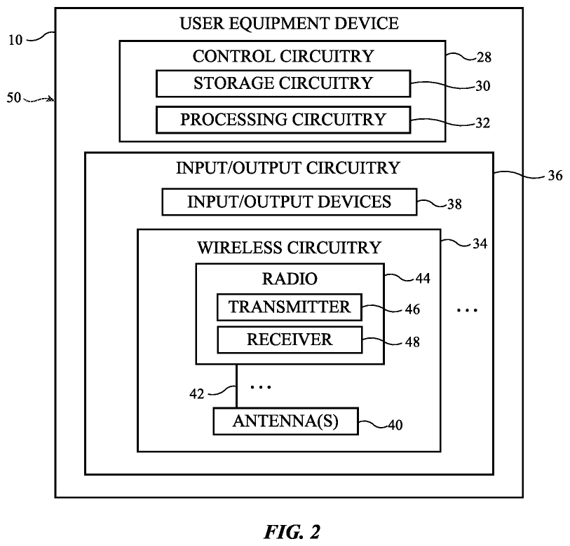

FIG. 2 is a block diagram of an illustrative UE device 10. UE device 10 is an electronic device and may therefore sometimes be referred to herein as electronic device 10 or device 10. UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in FIG. 2, UE device 10 may include components located on or within an electronic device housing such as housing 50. Housing 50, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 50 may be formed from dielectric or other low-conductivity material (e.g., glass, ceramic, plastic, sapphire, etc.). In other situations, housing 50 or at least some of the structures that make up housing 50 may be formed from metal elements.

UE device 10 may include control circuitry 28. Control circuitry 28 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 30 may include storage that is integrated within UE device 10 and/or removable storage media.

Control circuitry 28 may include processing circuitry such as processing circuitry 32. Processing circuitry 32 may be used to control the operation of UE device 10. Processing circuitry 32 may include on one or more processors such as microprocessors, microcontrollers, digital signal processors, host processors, baseband processor integrated circuits, application specific integrated circuits, central processing units (CPUs), graphics processing units (GPUs), etc. Control circuitry 28 may be configured to perform operations in UE device 10 using hardware (e.g., dedicated hardware or circuitry), firmware, and/or software. Software code for performing operations in UE device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 28 may be used to run software on device 10 such as one or more software applications (apps). The applications may include satellite navigation applications, internet browsing applications, voice-over-internet-protocol (VOIP) telephone call applications, email applications, media playback applications, operating system functions, gaming applications, productivity applications, workplace applications, augmented reality (AR) applications, extended reality (XR) applications, virtual reality (VR) applications, scheduling applications, consumer applications, social media applications, educational applications, banking applications, spatial ranging applications, sensing applications, security applications, media applications, streaming applications, automotive applications, video editing applications, image editing applications, rendering applications, simulation applications, camera-based applications, imaging applications, news applications, and/or any other desired software applications.

Each application may have one or more corresponding application usage types associated with the wireless data pattern required by that application during operation. For example, an application may have a latency-sensitive usage type, a throughput-sensitive usage type, a connection establishment usage type (e.g., a massive connection establishment usage time or a usage type associated with uplink-centric applications), etc. The latency-sensitive usage type may indicate that the application requires the transmission and/or reception of wireless data with as low a latency as possible (e.g., to avoid disrupting the user's experience with the application). As an example, a video or voice call application may have a latency-sensitive usage type because such applications are particularly sensitive to latency, which can drop or interrupt a video or voice call with another device. As another example, a video streaming application may have a throughput-sensitive usage type because such applications require high data throughput (e.g., to download high resolution video data to the UE device). Applications with the connection establishment usage type may require more than a threshold amount of time to establish a connection with the network for conveying wireless data. Applications may be characterized by other usage types if desired. The pattern with which an application requires the transmission and/or reception of different amounts of wireless data over time is sometimes referred to herein as the TX/RX pattern of the application. Different usage types may be associated with different TX/RX patterns.

To support interactions with external communications equipment, control circuitry 28 may be used in implementing communications protocols. Communications protocols that may be implemented using control circuitry 28 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, 6G protocols, cellular sideband protocols, etc.), device-to-device (D2D) protocols, antenna diversity protocols, satellite navigation system protocols (e.g., global positioning system (GPS) protocols, global navigation satellite system (GLONASS) protocols, etc.), antenna-based spatial ranging protocols, or any other desired communications protocols. Each communications protocol may be associated with a corresponding radio access technology (RAT) that specifies the physical connection methodology used in implementing the protocol (e.g., an NR RAT, an LTE RAT, a 3G RAT, a WLAN RAT, etc.). Radio-frequency signals conveyed using a cellular telephone protocol may sometimes be referred to herein as cellular telephone signals.

UE device 10 may include input-output circuitry 36. Input-output circuitry 36 may include input-output devices 38. Input-output devices 38 may be used to allow data to be supplied to UE device 10 and to allow data to be provided from UE device 10 to external devices. Input-output devices 38 may include user interface devices, data port devices, and other input-output components. For example, input-output devices 38 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 38 may be peripherals that are coupled to a main processing unit or other portion of UE device 10 via a wired or wireless link).

Input-output circuitry 36 may include wireless circuitry 34 to support wireless communications. Wireless circuitry 34 (sometimes referred to herein as wireless communications circuitry 34) may include one or more antennas 40. Wireless circuitry 34 may also include one or more radios 44. Radio 44 may include circuitry that operates on signals at baseband frequencies (e.g., baseband circuitry) and radio-frequency transceiver circuitry such as one or more radio-frequency transmitters 46 and one or more radio-frequency receivers 48. Transmitter 46 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 40. Receiver 48 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 40. The components of radio 44 may be mounted onto a single substrate or integrated into a single integrated circuit, chip, package, or system-on-chip (SOC) or may be distributed between multiple substrates, integrated circuits, chips, packages, or SOCs.

Antenna(s) 40 may be formed using any desired antenna structures for conveying radio-frequency signals. For example, antenna(s) 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 40 over time. If desired, two or more of antennas 40 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction (e.g., towards base station 12 of FIG. 1).

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 40 may transmit the radio-frequency signals by radiating the radio-frequency signals into free space (or to free space through intervening device structures such as a dielectric cover layer). Antenna(s) 40 may additionally or alternatively receive the radio-frequency signals from free space (e.g., through intervening devices structures such as a dielectric cover layer). The transmission and reception of radio-frequency signals by antennas 30 each involve the excitation or resonance of antenna currents on an antenna resonating element in the antenna by the radio-frequency signals within the frequency band(s) of operation of the antenna.

Each radio 44 may be coupled to one or more antennas 40 over one or more radio-frequency transmission lines 42. Radio-frequency transmission lines 42 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines 42 may be integrated into rigid and/or flexible printed circuit boards if desired. One or more radio-frequency lines 42 may be shared between multiple radios 44 if desired. Radio-frequency front end (RFFE) modules may be interposed on one or more radio-frequency transmission lines 42. The radio-frequency front end modules may include substrates, integrated circuits, chips, or packages that are separate from radios 44 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines 42.

Radio 44 may transmit and/or receive radio-frequency signals within corresponding frequency bands at radio frequencies (sometimes referred to herein as communications bands or simply as “bands”). The frequency bands handled by radio 44 may include wireless local area network (WLAN) frequency bands (e.g., Wi-Fi® (IEEE 802.11) or other WLAN communications bands) such as a 2.4 GHZ WLAN band (e.g., from 2400 to 2480 MHz), a 5 GHZ WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHZ, 5G New Radio Frequency Range 2 (FR2) bands between 20 and 60 GHZ, cellular sidebands, 6G bands between 100-1000 GHZ (e.g., sub-THz, THz, or THE bands), etc.), other centimeter or millimeter wave frequency bands between 10-300 GHZ, near-field communications frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, industrial, scientific, and medical (ISM) bands such as an ISM band between around 900 MHZ and 950 MHz or other ISM bands below or above 1 GHZ, one or more unlicensed bands, one or more bands reserved for emergency and/or public services, and/or any other desired frequency bands of interest. Wireless circuitry 34 may also be used to perform spatial ranging operations if desired.

The example of FIG. 2 is illustrative and non-limiting. While control circuitry 28 is shown separately from wireless circuitry 34 in the example of FIG. 1 for the sake of clarity, wireless circuitry 34 may include processing circuitry (e.g., one or more processors) that forms a part of processing circuitry 32 and/or storage circuitry that forms a part of storage circuitry 30 of control circuitry 28 (e.g., portions of control circuitry 28 may be implemented on wireless circuitry 34). As an example, control circuitry 28 may include baseband circuitry (e.g., one or more baseband processors), digital control circuitry, analog control circuitry, and/or other control circuitry that forms part of radio 44. The baseband circuitry may, for example, access a communication protocol stack on control circuitry 28 (e.g., storage circuitry 30) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer. If desired, the PHY layer operations may additionally or alternatively be performed by radio-frequency (RF) interface circuitry in wireless circuitry 34.

It may be desirable to simultaneously receive and/or transmit radio-frequency signals at two or more different frequencies, sometimes referred to herein as component carriers (CCs), to increase data throughput for UE device 10. For example, UE device 10 may communicate using one or more communications protocols that support carrier aggregation (CA) and/or dual connectivity (DC) schemes (e.g., a 3GPP 5G NR FR1 and/or FR2 protocol, a Long Term Evolution (LTE) protocol, a 6G protocol, etc.). Under a CA scheme, wireless data is conveyed at each of the different frequencies (e.g., using each of the different CCs) using the same radio access technology (RAT). Under a DC scheme, wireless data is conveyed at two or more different frequencies (e.g., using each of the different CCs) using two or more different RATs.

By concurrently conveying wireless data using two or more CCs (e.g., using a CA or DC scheme), UE device 10 may be provided with increased data bandwidth relative to scenarios where only a single frequency is used. If desired, UE device 10 may simultaneously communicate with two or more base stations using two or more different CCs (e.g., device 10 may perform CA or DC over or with multiple base stations). For example, UE device 10 may simultaneously communicate with both a first base station 12 and with a second base station 12 using the CA or DC scheme. UE device 10 may concurrently communicate with additional base stations 12 if desired (e.g., at additional frequencies).

Prior to conveying wireless signals via network 22, UE device 10 may first establish a wireless connection to one of the base stations 12 (cells) of network 22. The wireless connection may have or may implement an associated network configuration (sometimes referred to herein as a connectivity configuration, a wireless configuration, connection configuration, or a network connection configuration). The network configuration may specify wireless parameters associated with the wireless connection between UE device 10 and the network or base station. The network configuration may, for example, specify the bandwidth (BW) of the wireless connection, the RAT used to support the wireless connection, the component carrier (CC) configuration of the wireless connection (e.g., identifying the number of CCs used to support the wireless connection), carrier aggregation (CA) settings for the wireless connection, timing or synchronization information for the wireless connection, scheduling information for the wireless connection, frequency settings for the wireless connection, beamforming settings for the wireless connection, a connected mode discontinuous reception (CDRX) configuration, etc. The CDRX configuration may, for example, specify the duration with which the radio in UE device 10 is asleep between reception of data packets.

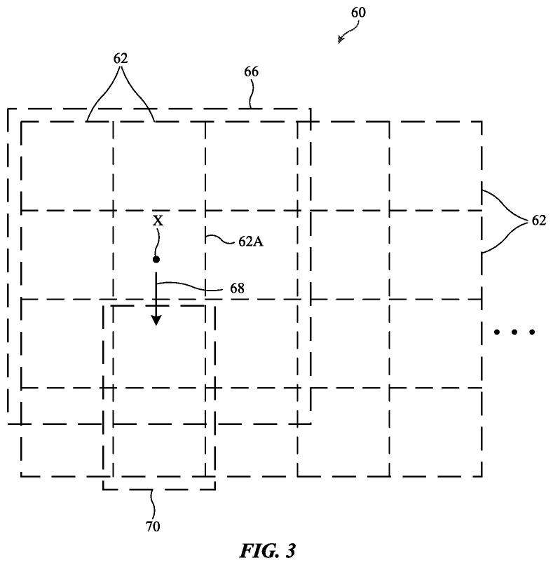

In practice, different network configurations may allow UE device 10 to exhibit optimal wireless performance at different locations as the UE device moves across Earth. FIG. 3 is a diagram showing a geographic region 60 on Earth in which UE device 10 is located. Region 60 may span a local area, neighborhood, town, city, county, state, province, country, continent, or all of Earth, as examples. As shown in FIG. 3, UE device 10 may be at a location X in geographic region 60. Geographic region 60 may be logically divided into a number of tiles 62. Each tile 62 may span a corresponding area (e.g., 1 square km or other areas). Each tile 62 may span a single cell of a corresponding base station 12, may span a portion of a single cell, or may span multiple cells of multiple base stations 12.

Device 10 may move across geographic region 60 over time, as shown by arrow 68. UE device 10 may identify its current position (e.g., location X) and/or its motion across region 60 using one or more sensors on the UE device. For example, UE device 10 may use a satellite navigation receiver (e.g., GPS signals), motion or orientation sensors (e.g., accelerometers, gyroscopes, compasses, etc.), radio or optical spatial ranging signals (e.g., radar or lidar signals), and/or wireless signals received from external equipment to identify its current position and/or its motion across region 60. In practice, UE device 10 may need to use different network configurations in different tiles 62 to optimize its wireless performance in communicating with the network.

The wireless capabilities of base stations 12 continue to evolve over time. For example, base stations 12 are often reconfigured to exhibit greater aggregated bandwidths and CA orders (e.g., where CA order is proportional to the number of active CCs used under the CA scheme) and/or may support dual connectivity with the NR protocol. In some implementations, when a UE device initiates (establishes) a wireless connection with a base station 12 to request wireless data required by an application running on the UE device, the network configures the UE device to communicate using a network configuration that is agnostic with respect to the operating context of the UE device. This may lead to excessive power consumption on the UE device.

For example, when the UE device attempts to initiate the wireless connection, the network does not have knowledge of the application the UE device is running that requires wireless data transfer. Similarly, the network does not have knowledge of the latency and throughput required by the UE device to convey the wireless data required by the application. As such, the network will assume a worst case scenario (e.g., that the application is both a throughput and latency-sensitive application that requires as many communication resources as possible). The network will thereby assign the UE device a network configuration that supports as high a performance level as possible (e.g., that supports as much throughput and as little latency as possible, that has a high CA order, that utilizes NR DC, etc.) to best ensure that the UE device is able to establish and maintain the wireless connection.

However, in practice, most applications running on the UE device will not actually require such a worst-case scenario network configuration to exhibit satisfactory levels of performance. For example, as little as 10% of the resources of radio 44 may be sufficient to convey the wireless data required by 95% of applications running on the UE device. Since radio 44 (FIG. 1) consumes more resources (e.g., power, chip area, processing resources, etc.) when configured using higher performance network configurations than lower performance network configurations, providing UE device 10 with a worst-case scenario network configuration can cause the UE device to consume an excessive amount of power and otherwise wastes resources on the UE device. In addition, once the wireless connection is established, the UE device and the network may maintain the network configuration even when the application does not actively transmit or receive wireless data (e.g., because the network does not have upfront knowledge of the per-application TX/RX pattern of the UE device and therefore cannot adapt its CDRX configuration accordingly).

In some implementations, the UE device performs reactive adjustments to its network configuration to help reduce excess power consumption. The reactive adjustments can involve disabling some of the data or resource-intensive features of the network configuration assigned to the UE device by the network (e.g., releasing an NR link, reducing the number of active CCs, etc.). However, reactive adjustments can still consume excessive power, because the UE device will consume a large amount of power until the UE device decides to react to excessive power consumption and/or thermal load. Reactive adjustments can also be disruptive to wireless communications, as the reactive adjustments will greatly reduce throughput while thermal conditions on the UE device are allowed to stabilize (e.g., causing the UE device to convey wireless data with a bursty performance cycle as communications capabilities are downgraded when the UE device enters a thermal constraint and then upgraded after the UE device exits the thermal constraint).

To mitigate these issues, UE device 10 may proactively identify an optimal network configuration for itself that will allow UE device 10 to satisfy its wireless data transfer needs while minimizing or eliminating unnecessary resource consumption. UE device 10 may proactively identify the optimal network configuration based on contextual information generated locally at UE device 10 and/or based on contextual information generated by the set 18 of other UE devices in system 20. The contextual information may be aggregated at DCS 24 (FIG. 1) and may be provided to UE device 10 as needed (e.g., upon request by UE device 10). Put differently, UE device 10 may crowd-source some of its decision making in selecting the optimal network configuration to the set 18 of other UE devices (via DCS 24).

For example, UE device 10 may assess the correlation of different potential network configurations in the field to the applications running on the UE device and wireless performance metric data (e.g., a key performance indicator (KPI)) to estimate the related power consumption footprint. UE device 10 may derive the per-application optimal network configuration (e.g., CDRX configuration) based on the per-application TX/RX patterns identified in the contextual information aggregated by DCS 24 from the set 18 of other UE devices. DCS 24 may, for example, transmit two tables to UE device 10: a cellular tower configuration to power consumption mapping table (sometimes referred to herein as a network configuration table) and a per-application best CDRX configuration index table. The cellular tower configuration to power consumption mapping table may contain, per base station (each of which has a specific global cell identifier (GCI), sometimes also referred to herein as CellID), one optimal network configuration per application that the former supports (e.g., one value per application, for the most popular applications on that specific CGI). The term “optimal” as used herein may be in terms of the applications power consumption footprint being the lowest when using such a chosen network configuration.

Then, when connecting to a specific cell, the UE device may use the tables to proactively select which of the different network configurations to assign as the optimal network configuration based on the needs and context of the applications running on the UE device and the power consumption constraints and battery state of the UE device. Once the UE device has identified the optimal network configuration, the UE device may transmit information to the network (e.g., a base station 12) identifying or requesting the optimal network configuration. The information may include, for example, a 3GPP R16 UEAssistanceInformation message (e.g., based on the network-indicated support of a particular user assisted information (UAI) feature and UE capability information to support requesting such preferred connected mode metrics). The optimal network configuration may also be implemented by pruning UE capabilities, virtual configuration releases, and/or a UE-controlled sleep mechanism. For a given application, if its optimal network configuration is not available at a particular location, then the UE device may choose from available network configurations and may request the available network configuration closest to the optimal network configuration (e.g., closest in terms of the configuration's importance to the application's primary KPI).

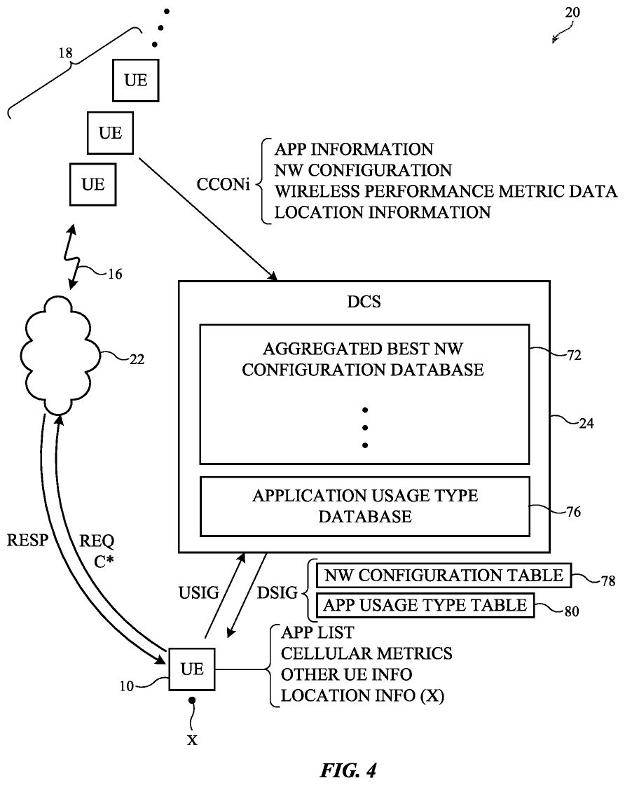

FIG. 4 is a diagram showing how UE device 10 may proactively identify an optimal network configuration based on contextual information generated locally at UE device 10 and based on contextual information generated by the set 18 of other UE devices in system 20. As shown in FIG. 4, a set 18 of UE devices may perform wireless communications with network 22 using respective wireless connections (e.g., using radio-frequency signals 16 conveyed with one or more base stations). The UE devices in set 18 may be distributed at different locations across one or more tiles 62 on Earth (FIG. 3).

Each of the UE devices in set 18 (e.g., the i^{th} UE device in set 18) may generate UE contextual information CCONi characterizing its wireless connection with network 22. Contextual information CCONi for the i^{th} UE device in set 18 may include application information identifying the application(s) that are running on the UE device and conveying wireless data over the wireless connection, network (NW) configuration information identifying the network configuration and/or one or more components (settings) of the network configuration used by the UE device for the wireless connection, information identifying the network operator associated with the base station the UE device communicates with over the wireless connection, information identifying the cell associated with the base station the UE device communicates with over the wireless connection (e.g., the GCI of the base station), wireless performance metric data associated with the transmission and/or reception of the wireless data over the wireless connection, and/or location information associated with the UE device.

The location information may identify the current location and/or the motion of the UE device while conveying the wireless data over the wireless link. The wireless performance metric data may include any desired performance metric information characterizing the wireless performance of the UE device in transmitting and/or receiving wireless data over the wireless link. The wireless performance metric data may include one or more KPIs, signal-to-noise ratio (SNR) values, received signal strength values, received signal strength indicator (RSSI) values, sensitivity values, noise floor values, error rate values, transmit power levels, quality values, data rate values, throughput values, latency values, and/or any other desired wireless performance metric information. Each of the UE devices in set 18 may transmit its contextual information CCONi to DCS 24 for aggregation and further processing.

DCS 24 may receive contextual information CCONi (sometimes referred to herein as UE contextual reports CCONi) from the set 18 of UE devices in system 20 (e.g., via one or more network nodes of network 20 such as base stations 12, WLAN routers, the Internet, etc.). DCS 24 may include one or more processors that aggregate and store the contextual information in a best network (NW) configuration database 72 (or any other data structure stored on storage circuitry at DCS 24). DCS 24 may, for example, aggregate contextual information CCONi based on the location where the contextual information CCONi was generated (e.g., DCS 24 may group the data from the UE contextual reports based on the tile 62 (FIG. 3) corresponding to the location identified in the UE contextual report). DCS 24 may then average the KPIs identified by the UE contextual reports per operator, such that database 72 lists, for each location (tile 62) and KPI, the preferred or best network configuration to use for wireless communications. A preferred or best network configuration may be preferred or best in the sense that a smaller or less resource-intensive network configuration (e.g., consuming less bandwidth, fewer CCs, fewer antennas, a less-intensive RAT, etc.) would imply a significant detriment in KPI but a larger or more resource-intensive network configuration would not yield a significant performance gain. In practice, the preferred network configuration may be constant at all positions across a given tile 62. If not, the preferred network configuration may also be determined based on the GCI level and stored in database 72 on the cell level (e.g., the entries of database 72 may be grouped on the tile level or on the cell level). Alternatively, DCS 24 may use a combination where tile-level data is the preferred configuration for most cells in a tile and then there is a cell-level list of preferred configurations for cells that are different from the tile-level data. Database 72 may be stored as a look up table or other data structure.

DCS 24 may also aggregate information that maps different applications to the expected or typical TX/RX pattern(s) of the applications and/or to their usage types in application usage type database 76. Each entry of database 76 may, for example, identify whether different applications or classes of applications are latency-sensitive, throughput-sensitive, require connection establishment time, etc. Database 76 may be stored as a look up table or other data structure.

UE device 10 may locally generate UE contextual information (e.g., contextual information local to UE device 10). The UE contextual information may include an application list (“APP LIST”) identifying one or more applications running on UE device 10 and/or predicted to run on UE device 10 in the future that require wireless data transfer. If desired, the application list may identify the application usage type of each of the applications. The UE contextual information may include one or more cellular metrics (“CELLULAR METRICS”) such as the GCI of the cell where the UE device is located.

If desired, the UE contextual information may include location information (“LOCATION INFO”). The location information may include the current location of UE device 10 (e.g., location X of FIG. 3), information identifying the current tile 62 in which UE device 10 is located (e.g., tile 62A of FIG. 3, which contains location X), information identifying the motion of UE device 10 (e.g., information identifying that UE device 10 is moving in the direction of arrow 68 of FIG. 3), and/or information identifying one or more predicted future locations of UE device 10 (e.g., based on historical/statistical usage data of UE device 10, information generated by an application on UE device 10 such as a navigation application or taxi application mapping a travel route for the UE device, etc.). If desired, the UE contextual information may include other contextual information (“OTHER UE INFO”) such as information about the current or expected future power consumption of UE device 10, information about the charging state of UE device 10 (e.g., identifying whether UE device 10 is currently plugged into a power source, currently receiving wireless power to charge a battery on the device, etc.), information about a battery state of UE device 10 (e.g., identifying the capacity and/or charged percentage of a battery on UE device 10), etc.

UE device 10 may transmit UE signal USIG to DCS 24. UE signal USIG may identify some or all of the UE contextual information generated at UE device 10. For example, UE information USIG may identify the current location of UE device 10 (e.g., latitude and longitude) and/or a set of tiles 62 for which UE device 10 needs information from best NW configuration database 72. UE device 10 may identify the set of tiles 62 based on the location information in the UE contextual information. For example, UE device 10 may include, in the set of tiles, the tile 62 in which the UE device is located (e.g., tile 62A of FIG. 3, which contains location X), one or more tiles adjacent to, neighboring, or around the tile in which the UE device is located (e.g., the group of tiles 66 around tile 62A in FIG. 3), one or more tiles 62 in which the UE device expects to be located based on its current motion (e.g., the group of tiles 70 in the direction of motion of UE device 10 when UE device 10 moves as shown by arrow 68 of FIG. 3), one or more tiles 62 neighboring the tile in which the UE device expects to be located based on its current motion, one or more tiles 62 in which the UE device expects to be located based on an application running on UE device 10 (e.g., a group of tiles along and/or neighboring a route and/or destination of a navigation, ride-sharing, or taxi application running on UE device 10, etc.). Additionally or alternatively, UE information USIG may also identify the operator UE device 10 uses to communicate with network 22 or information identifying a change in operator. Additionally or alternatively, UE information USIG may also identify some or all of the application list from the UE contextual information.

UE device 10 may use UE signal USIG to request one or more entries from best NW configuration database 72 and/or application usage type database 76. DCS 24 may include a transmitter that transmits the requested entries to UE device 10 in DCS signal DSIG. For example, DCS 24 may include, in DCS signal DSIG, the entries from best NW configuration database 72 corresponding to the tiles 62 in the set of tiles identified by UE signal USIG, the operator identified by UE signal USIG, and/or the application usage type(s) in the application list identified by UE signal USIG. The entries may, for example, collectively form a NW configuration table 78 transmitted to UE device 10. DCS 24 may also include in DCS signal DSIG some or all of application usage type database 76 (e.g., entries from database 76 corresponding to the applications in the application list of the UE contextual information). The entries may, for example, collectively form an application usage type table 80 transmitted to UE device 10. UE signal USIG and DCS signal DSIG may be conveyed over one or more intervening network nodes of system 22 between UE device 10 and DCS 24 (e.g., one or more base stations 12, WLAN routers, the Internet, etc.).

UE device 10 may identify the optimal network configuration based on its local UE contextual information and based on the contextual information aggregated (crowd-sourced) from the set 18 of other UE devices as included in DCS signal DSIG. For example, the UE device may identify the optimal network configuration based on NW configuration table 78, application usage type table 80, and/or the other UE information from its local UE contextual information. The optimal network configuration may be the network configuration that, based on the experience of the set 18 of other UE devices, is statistically likely to offer an optimal level of wireless performance for UE devices located at the current (or future) location of UE device 10, operating with the same operator and same application usage type, and/or operating with similar UE context (e.g., for the given power/battery constraints of the UE device, the corresponding cell in which the UE device is located, etc.). For example, if UE device 10 is running a movie streaming application in tile 62A, the optimal network configuration may be a network configuration that produced peak wireless performance metric data averaged across other UE devices from set 18 when the other UE devices were running the movie streaming application within tile 62A, communicating using the same operator, and/or had other similar local contextual information. The optimal network configuration may sometimes also be referred to herein as optimal network configuration C*.

UE device 10 may transmit a request REQ to network 22 (e.g., one or more base stations) to perform communications using the identified optimal network configuration C*. Network 22 may transmit a response RESP to UE device 10 confirming the optimal network configuration C*. UE device 10 and network 22 may thereafter perform communications using optimal network configuration C* (e.g., over a wireless connection that implements or that is maintained according to optimal network configuration C*). Alternatively, UE device 10 may proactively begin communicating using the identified optimal network configuration C* without first transmitting a requesting to network 22 and/or network 22 and UE device 10 may begin to communicate using optimal network configuration C* without network 22 transmitting response RESP. Request REQ and response RESP may, for example, be transmitted using radio resource control (RRC) signaling (e.g., using UAI messages of the RRC or in an RRC signal) once UE device 10 has entered an RRC connected mode with the network.

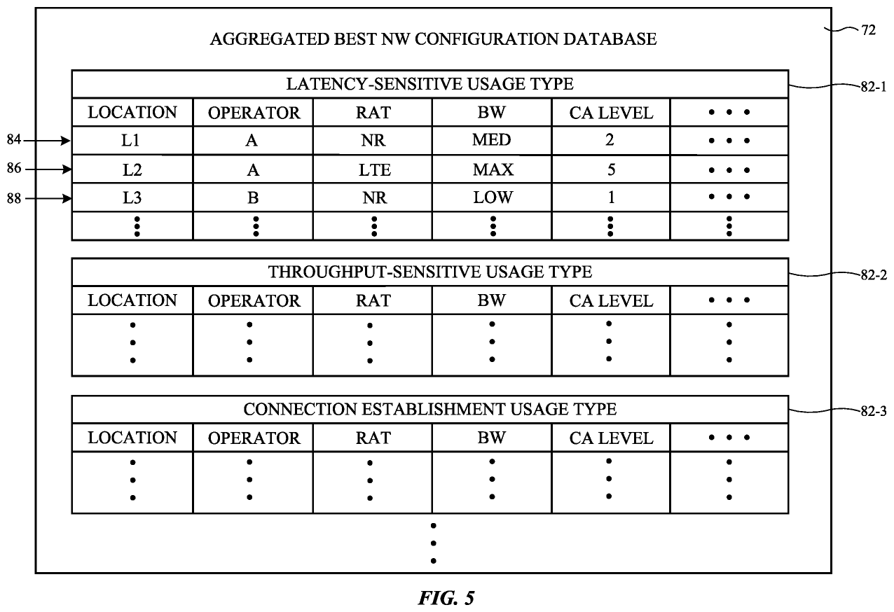

FIG. 5 is a diagram of best NW configuration database 72 on DCS 24. As shown in FIG. 5, database 72 may include one or more tables 82 of entries. Each of the entries may be populated by combining (e.g., aggregating and/or averaging) corresponding contextual information CCONi received from the set 18 of other UE devices in system 20. Each table 82 may correspond to a different application usage type (e.g., DCS 24 may group data from the received contextual information CCONi by application usage type). For example, database 72 may include a table 82-1 of data gathered (by the set 18 of other UE devices) for applications having the latency-sensitive usage type, a table 82-2 of data gathered for applications having the throughput-sensitive usage type, a table 82-3 of data gathered for applications having the connection establishment usage type, etc.

Each entry (row) in each table 82 may list the preferred network configuration settings (e.g., a set of radio resource control (RRC), data radio bearer (DRB), and physical layer configurations such as bandwidth, RAT, CA level, MIMO configuration, DRX information, etc.) for the combination of location and operator when using an application of the corresponding usage type to convey wireless data. For example, as shown in table 82-1, row 84 lists the preferred network configuration for UE device 10 to use when at a location L1 and using operator A. Location may be grouped by coordinates, by cells, or by tiles 62 (FIG. 3). As such, location L1 may correspond to a particular tile 62, a particular cell (e.g., GCI or CELLID), or to a particular location X (FIG. 3).

As shown in row 84, UE device 10 may achieve optimal wireless performance while at location L1 and using operator A when communicating using a network configuration that includes the NR RAT, a medium (MED) bandwidth, a carrier aggregation level of 2, etc. The fields of row 84 may be populated by DCS 24 based on the combination of contextual information CCONi received from the set 18 of other UE devices. For example, DCS 24 may identify from the wireless performance metric data in contextual information CCONi that, on average, that the other UE devices exhibited peak wireless performance (when using a latency-sensitive application at location L1 and when communicating with operator A) under a network configuration that includes the NR RAT, a medium bandwidth, a carrier aggregation level of 2, etc. DCS 24 may then populate row 84 accordingly.

Similarly, as shown in row 86, UE device 10 may achieve optimal wireless performance while at location L2 and using operator A when communicating using a network configuration that includes the LTE RAT, a maximum (MAX) bandwidth, a carrier aggregation level of 5, etc. As shown in row 88, UE device 10 may achieve optimal wireless performance while at location L3 and using operator B when communicating using a network configuration that includes the NR RAT, a low bandwidth, a carrier aggregation level of 1, etc. In this way, each row of table 82-1 may identify a respective preferred network configuration (as aggregated from contextual information CCONi crowd-sourced from the set 18 of other UE devices) for each location L from a set of different locations L when using applications having the latency-sensitive usage type. Similarly, each row of table 82-2 may identify a respective preferred network configuration (as aggregated from contextual information CCONi crowd-sourced from the set 18 of other UE devices) for each location L from a set of different locations L when using applications having the throughput-sensitive usage type, each row of table 82-3 may identify a respective preferred network configuration for each location L when using applications having the connection establishment usage type, etc.

UE device 10 may query or read one or more entries from database 72 (e.g., using UE signal USIG) when identifying optimal network configuration C*. DCS 24 may transmit those entries of database 72 to UE device 10 (e.g., using DCS signal DSIG). For example, when the UE contextual information identifies that UE device 10 is located in a tile 62 corresponding to location L1 that is neighbored by a tiles 62 corresponding to locations L2, the UE contextual information identifies that UE device 10 is using a latency-sensitive application, and the UE contextual information identifies that UE device 10 is using operator A, UE device 10 may use UE signal USIG to request rows 84 and 86 from table 82-1 of database 72. DCS 24 may use DCS signal DSIG to transmit rows 84 and 86 from table 82-1 to UE device 10 (e.g., as NW configuration table 78 of FIG. 4). UE device 10 may then select its optimal network configuration C* as whichever of rows 84 and 86 maximizes its wireless performance while concurrently minimizing power consumption given its current UE contextual information (e.g., given the current application running on UE device 10, the current cellular metrics, the power consumption of the UE device, the battery state of the UE device, etc.). UE device 10 may request the optimal network configuration C* from network 22 (e.g., using UAI messages) and may then establish and maintain a wireless connection with network 22 using optimal network configuration C*.

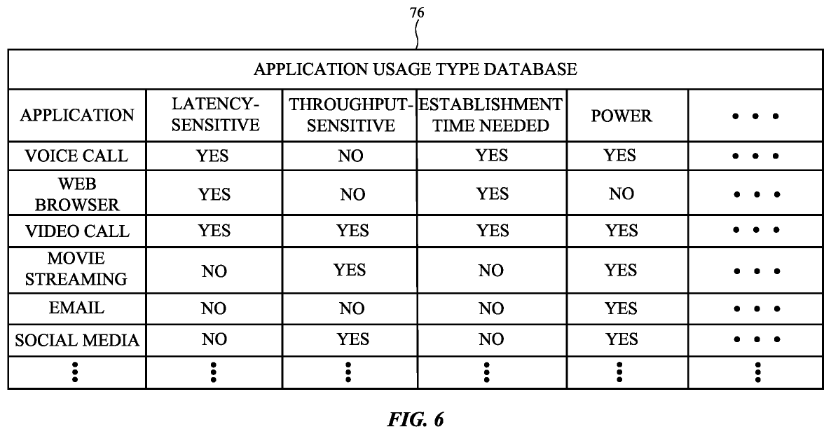

FIG. 6 is a diagram of application usage type database 76 on DCS 24 of FIG. 4. As shown in FIG. 6, database 76 may include a set of entries (rows). Each of the entries may identify whether a particular application or class of applications is latency-sensitive (the latency-sensitive usage type), throughput-sensitive (the throughput-sensitive usage type), power sensitive (e.g., requires more than a threshold amount of power), requires connection establishment (e.g., requires a predetermined amount of time to establish a connection), etc.

For example, as shown in FIG. 6, a voice call application (e.g., a particular voice call application or a class of applications that perform voice calling) may be latency sensitive, may be power sensitive, may require establishment time, but may not be throughput-sensitive, a web browser application may be latency-sensitive, may require establishment time, but may not be throughput or power-sensitive, etc. DCS 24 may populate the entries of database 76 using contextual information CCONi and/or other information received from network 22 or elsewhere in system 20. UE device 10 may receive some or all of database 76 from DCS 24 (e.g., in DCS signal DSIG or in a separate signal). UE device 10 may use database 76 to identify the usage type of the application(s) running on UE device 10 (e.g., the application(s) in the application list of the local UE contextual information that require or will require wireless data transfer). UE device 10 may then use the identified usage type to know which entries in best NW configuration database 72 to request (e.g., entries from the table 82 corresponding to the usage type of the application(s) requiring wireless data transfer) and/or to select optimal network configuration C*. For example, if UE device 10 is about to use a voice call application, UE device 10 may identify from database 76 that the voice call is latency-sensitive and requires establishment time. UE device 10 may then filter the received NW configuration table 78 to only include entries from tables 82-1 and 82-3 (FIG. 5) and/or may request only entries from tables 82-1 and 82-3 in database 72 (e.g., entries corresponding to the current location and operator of UE device 10).

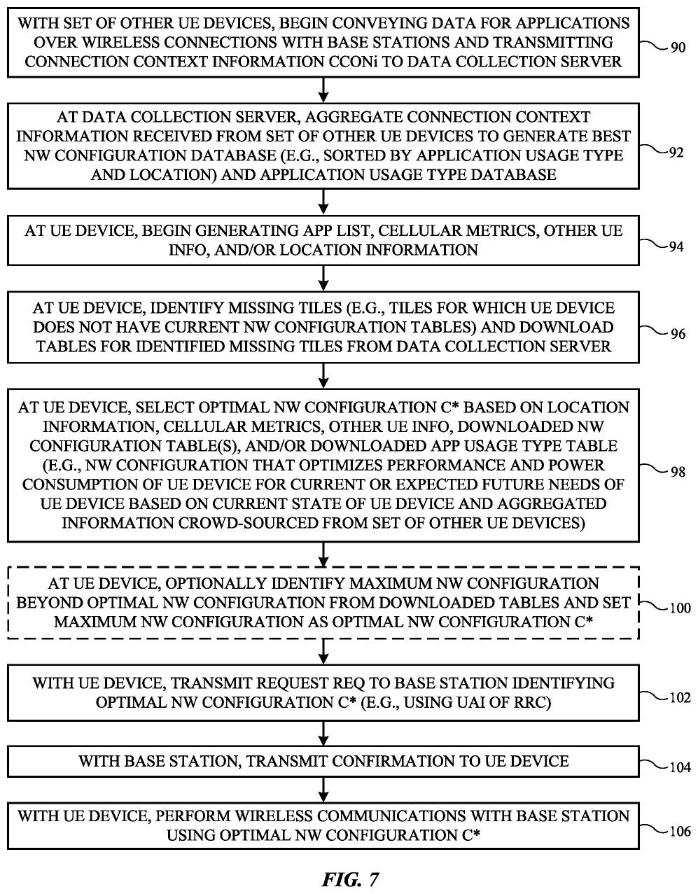

FIG. 7 is a flow chart of illustrative operations involved in establishing a wireless connection between UE device 10 and network 22 based on crowd-sourced information from the set 18 of other UE devices as aggregated at DCS 24 (FIG. 4).

At operation 90, the set 18 of other UE devices may begin conveying wireless data for applications running on the UE devices over wireless connections with one or more base stations of network 22. The set 18 of other UE devices may generate contextual information CCONi associated with the wireless connections. The set 18 of other UE devices may transmit contextual information CCONi to DCS 24 for storage and aggregation.

At operation 92, DCS 24 may aggregate the contextual information CCONi received from the set 18 of other UE devices into best NW configuration database 72 (FIGS. 4 and 5). DCS 24 may also generate and/or store application usage type database 76 (FIGS. 4 and 6). For example, DCS 24 may identify (e.g., generate, determine, output, estimate, etc.) the preferred network configuration for each combination of location, operator, and application usage type from the wireless performance metric data, location information, application information, and/or NW configuration information in the received contextual information CCONi. DCS 24 may store the preferred network configurations as entries (rows) in tables 82 of database 72 (FIG. 5).

At operation 94, which may be performed concurrently with operations 90 and/or 92, UE device 10 may begin to generate its local UE contextual information. For example, UE device 10 may begin to generate an application list, cellular metrics, location information, and/or other UE information.

At operation 96, UE device 10 may identify the set of tiles 62 for which the UE device needs to request entries from best NW configuration database 72 on DCS 24. The set of tiles may sometimes be referred to herein as missing tiles. The missing tiles may be tiles at or around the current location of UE device 10 and/or at or around predicted future locations of UE device 10 and for which the UE device does not have current entries from best NW configuration database 72 on DCS 24. Entries may not be “current” for a given tile 62 if UE device 10 does not have any entry for that tile 62, if more than a predetermined amount of time has passed since UE device 10 received an entry for that tile 62, and/or if one or more device conditions have changed since the UE device received an entry for that tile 62, as examples. UE device 10 may then transmit UE signal USIG to DCS 24 requesting or querying the entries of best NW configuration database 72 for the missing tiles. UE device 10 may then download the entries of best NW configuration database 72 for the missing tiles (e.g., as NW configuration table 78 in DCS signal DSIG). UE device 10 may also download some or all of application usage type database 76 from DCS 24.

At operation 98, UE device 10 may select (e.g., identify, generate, determine, output, produce, etc.) the optimal NW configuration C* based on the entries of best NW configuration database 72 received DCS 24, application usage type database 76, and some or all of the local UE contextual information generated at UE device 10. For example, UE device 10 may select the optimal NW configuration C* to be the entry (e.g., the preferred network configuration) received from best NW configuration database 72 that maximizes the wireless performance of UE device 10 at the current or expected future location, tile, and/or cell of UE device 10 when operating with the corresponding operator and application usage type identified by the local UE contextual information and that concurrently minimizes power consumption given the current power condition and/or battery level identified by the local UE contextual information. In this way, UE device 10 may crowd source some of its decision logic in identifying the optimal NW configuration to the set 18 of other UE devices and DCS 24.

At optional operation 100, which may be omitted, UE device 10 may identify a maximum NW configuration beyond the optimal NW configuration from the downloaded entries of best NW configuration database 72. The maximum NW configuration may, for example, offer higher performance and/or may consume more power than the optimal NW configuration. UE device 10 may identify the maximum NW configuration when the downloaded entries of NW configuration database 72 identify that one or more of the other UE devices from set 18 successfully performed wireless communications with superior performance using some or all of the NW maximum NW configuration (e.g., one or more network configuration settings beyond those of the current optimal NW configuration) given similar contextual information to UE device 10, for example. When UE device 10 identifies the maximum NW configuration, the UE device may set the maximum NW configuration as optimal NW configuration C*.

At operation 102, UE device 10 may transmit request REQ to network 22 identifying or requesting optimal NW configuration C*. UE device 10 may transmit request REQ using an RRC UAI or using any other desired 3GPP signaling waveform. For example, once UE device 10 has established an RRC connection to a base station 12 (e.g., entering an RRC connected state), UE device 10 may begin to provide information identifying its capabilities to base station 12 using the RRC. The UE device and base station 12 may perform an RRC reconfiguration procedure using the UAI to request implementation of optimal NW configuration C*. For example, UE device 10 may transmit a UAI to base station 12 that identifies or conveys the optimal CDRX (e.g., drx-PreferenceConfig-r16), the maximum MIMO layer preference (e.g., max-MIMO-LayerPreferenceConfig-r16), the maximum CC preference configuration (e.g., maxCC-PreferenceConfig-r16), the maximum BW preference configuration (e.g., maxBW-PreferenceConfig-r16), the minimum scheduling offset (e.g., minSchedulingOffsetPreferenceConfig-r16), the maximum release preference configuration (e.g., releasePreferenceConfig-r16), and/or other features or settings (UAI parameters) associated with the optimal NW configuration C*. Each feature (UAI parameter) requested in the UAI may include an associated prohibit timer to ensure reasonable usage of UAI from the UE side. The optimal network configuration requests made via UAI are not binding to the network and the network can decide or agree to assign one or more of the requested settings to UE device 10. Alternatively, UE device 10 may begin to implement optimal NW configuration C* without transmitting request REQ.

At operation 104, base station 12 may transmit response RESP to UE device 10 (e.g., using RRC signaling) indicating whether the network has accepted the request and assigned some or all of optimal NW configuration C* to UE device 10 (e.g., identifying which of the UAI parameters from the request the NW has accepted and/or which of UAI parameters from the request the NW has rejected). If the network does not respond to the request after a predetermined time period, UE device 10 may re-transmit the request if desired.

At operation 106, UE device 10 and base station 12 may perform wireless communications using optimal NW configuration C* (or those features of the requested optimal NW configuration C* that were accepted by network 22). In other words, UE device 10 and base station 12 may convey wireless data over a wireless connection that implements optimal NW configuration C* (or those features of the requested optimal NW configuration C* that were accepted by network 22). The wireless communications may optimize wireless performance and power consumption (e.g., without consuming excessive power) without requiring reactive adjustments to the network configuration that would otherwise consume excessive power and/or disrupt wireless communications (e.g., by requiring bursty transmission/reception periods).

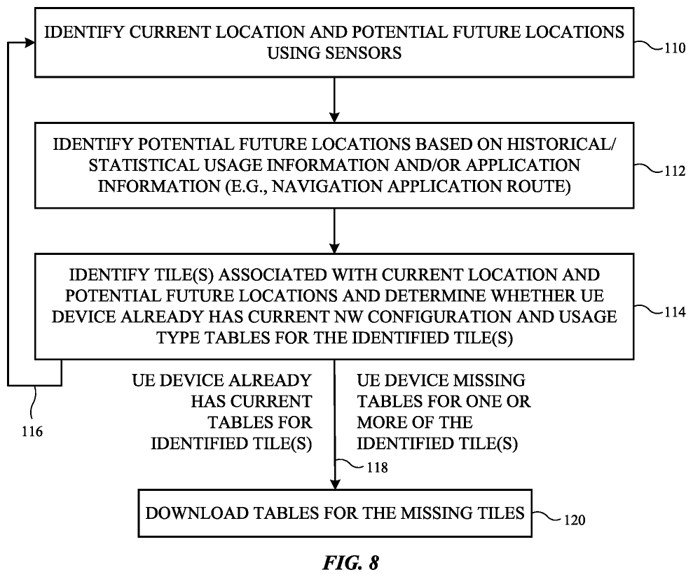

FIG. 8 is a flow chart of illustrative operations that may be performed by UE device 10 to download entries of database 72 from DCS 24 (FIG. 4) for a set of missing tiles 62. The operations of FIG. 8 may, for example, be performed while processing operation 96 of FIG. 7.

At operation 110, UE device 10 may identify its current location (e.g., location X of FIG. 3) and potential future locations using one or more sensors on UE device 10 (e.g., motion sensors, satellite navigation receivers, etc.). The potential future locations may, for example, include locations in the direction of motion of UE device 10 (e.g., the group of tiles 70 of FIG. 3 that UE device 10 is expected to enter based on its current motion).

At operation 112. UE device 10 may identify potential future locations based on historical/statistical usage information and/or application information. The historical/statistical usage information may, for example, identify locations where UE device 10 has traveled in the past at similar times and/or under similar operating contexts. The application information may, for example, include locations that the UE device is expected to visit according to an application running on the UE device (e.g., locations along a navigation route in a mapping, navigation application, ridesharing, or taxi application).

At operation 114, UE device 10 may identify a set of one or more tiles 62 associated with the identified current and/or potential future locations. The set of tiles may include tiles overlapping the current and/or potential future locations and/or tiles around, neighboring, or adjacent to the current and/or potential future locations (e.g., tiles within a fixed distance of the current and/or potential future locations). UE device 10 may also determine whether the UE device already has current entries from best NW configuration database 72 for the tiles in the set of tiles. The tiles from the set of tiles for which the UE device does not have current entries from best NW configuration database 72 may be referred to herein as missing tiles. If UE device 10 already has current entries from best NW configuration database 72 for all the tiles in the set of tiles (e.g., if there are no missing tiles), processing may loop back to operation 110 via path 116.

If UE device 10 does not have current entries from best NW configuration database 72 for one or more tiles in the set of tiles (e.g., if there are missing tiles), processing may proceed from operation 114 to operation 120 via path 118. At operation 120, UE device 10 may download the entries of best NW configuration database 72 from DCS 24 that correspond to the missing tiles. In this way, UE device 10 may process the entries of best NW configuration database 72 for tiles 62 at and/or around its current and/or predicted future locations for use in selecting optimal NW configuration C*.

UE device 10 may update its stored entries from best NW configuration database 72 as the UE device moves around (e.g., when moving to a different tile 62, the UE device may download entries for new neighboring tiles, etc.). The entries for the tiles may be stored or cached at UE device 10 for future use. If desired, entries for tiles overlapping known places or places where the UE device 10 historically or statistically is likely to travel (e.g., a home location, a work location, along a commute or navigation route, etc.) may be proactively downloaded in advance (e.g., when UE device 10 is connected to a Wi-Fi network and/or is being charged). Stored/cached data may be periodically updated (e.g., weekly) when UE device 10 is connected to a Wi-Fi network and/or is being charged, for example. Entries for tiles that have not been used for more than a predetermined time period may be purged or deleted to conserve memory. The application usage type database 76 stored on UE device 10 may also be downloaded or updated periodically (e.g., weekly).

The availability of a maximum NW configuration (e.g., as identified at operation 100 of FIG. 7) beyond an optimal NW configuration C* (e.g., as identified at operation 98 of FIG. 7) may allow for potential performance upgrades for UE device 10 beyond already observed configurations. As such, if the UE device is able to identify such a maximum NW configuration from the entries of database 72 received from DCS 24, the UE device may request the maximum NW configuration from DCS 24 (e.g., as a new optimal NW configuration C* requested at operation 102 of FIG. 7). This may serve to boost the performance of UE device 10 based on observations of the aggregated performance of the set 18 of other UE devices.

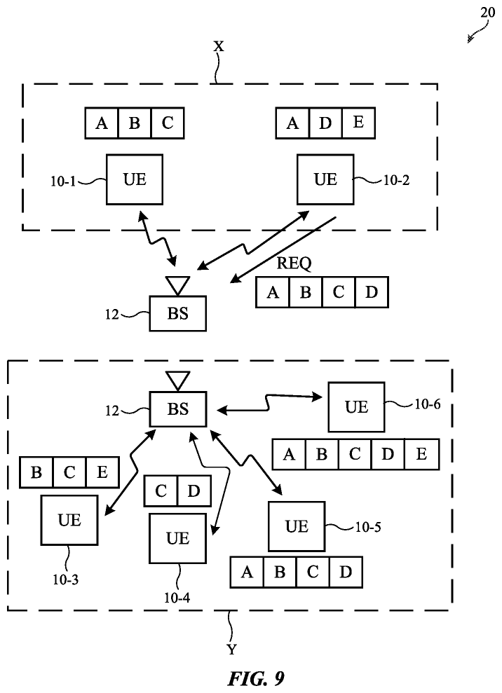

FIG. 9 is a diagram showing one example of how UE device 10 may request a maximum NW configuration that involves requesting additional CCs from base station 12. As shown in FIG. 9, UE devices such as UE devices 10-1 and 10-2 may be at a location X in system 20. UE device 10-1 may communicate with base station(s) 12 using three CCs A, B, and C. UE device 10-2 may communicate with base station(s) 12 using three CCs A, D, and E. UE devices 10-1 and 10-2 will report to DCS 24 (in contextual information CCONi (FIG. 4)) their corresponding CCs. DCS 24 may identify from the reports that location X has five available CCs: A, B, C, D, and E (e.g., from aggregating the CCs of UE 10-1 with the CCs of UE 10-2). DCS 24 may assume that the maximum number of CCs supported at location X is three (given the reports from UE 10-1 and UE 10-2) and may identify that the best performing combination of CCs is A, D. E (for example).

As shown in FIG. 9, UE devices such as UE devices 10-3, 10-4, 10-5, and 10-6 may be at a location Y in system 20. UE device 10-3 may communicate with base station(s) 12 using three CCs B, C, and E. UE device 10-4 may communicate with base station(s) 12 using two CCs C and D. UE device 10-5 may communicate with base station(s) 12 using four CCs A, B, C, and D. UE device 10-6 may communicate with base station(s) 12 using five CCs A, B, C, D, and E. DCS 24 may identify from the reports that location Y has five available CCs: A, B, C, D, and E (e.g., from aggregating the CCs of UE 10-3 through UE 10-6). DCS 24 may identify that the best performing combination of CCs is A, B, C, and D (for example).

DCS 24 or UE device 10-2 may compare or aggregate the data aggregated from UE 10-1 and UE 10-2 for location X with the data aggregated from UE 10-3 through UE 10-6 for location Y. DCS 24 or UE device 10-2 may thereby identify that the same five CCs A, B, C, D, and E are available at both location X and Y. DCS 24 or UE device 10 may compare the best performing combination of CCs for location Y (A, B, C, and D in this example) with the best performing combination of CCs for location X (A, D, and E in this example). If DCS 24 or UE device 10-2 determines that the best-performing combination of four CCs for location Y (A, B, C, and D) offers superior wireless performance to the best-performing combination of three CCs for location Y (A, D, and E), UE device 10-2 may identify that the best-performing combination of four CCs for location Y (A, B, C, and D) offers superior wireless performance to the best-performing combination of three CCs for location Y (A, D, and E). As such, UE device 10-2 may identify a maximum NW configuration for itself that includes an assignment of four CCs (A, B, C, and D) even though no UE device had previously used four CCs at location X. UE device 10 may set this maximum NW configuration as its optimal network configuration C*. UE device 10 may then transmit a request REQ to base station(s) 12 for an optimal NW configuration C* that includes an assignment of four CCs (A, B, C, and D) to UE device 10-2. In this way, UE device 10-2 may communicate over a wireless link that offers superior performance beyond those already observed for UE devices at its location X. This example is merely illustrative and, in general, UE device 10 may request any desired maximum NW configuration.

If desired, privacy for the UE devices in system 20 may be enhanced in various ways. For example, UE device 10 may identify optimal network configuration C* based only on its own local UE contextual information (e.g., historic/statistical usage of different applications at different locations with different performance levels) without considering contextual information crowd-sourced from the set 18 of other UE devices (e.g., the set 18 of other UE devices may forego transmission of contextual information CCONi to DCS 24, operations 90-92 of FIG. 7 may be omitted, etc.). Put differently, rather than uploading its own contextual information to DCS 24 and downloading table 78 from DCS 24 that aggregates contextual information from the set 18 of other UE devices, UE device 10 may only store its own UE contextual information locally (e.g., in a database or other data structure on UE device 10). The operations of FIGS. 7 and 8 may then be adapted such that data is collected only by UE device 10 itself and such that processing and table generation is performed on UE device 10 rather than on DCS 24. For known locations and applications (which is the dominant scenario for most users), UE device 10 can then identify optimal network configuration C* as a best performing network configuration from its own past observations (e.g., from wireless performance metric data gathered by UE device 10 at the same locations and using the same applications).

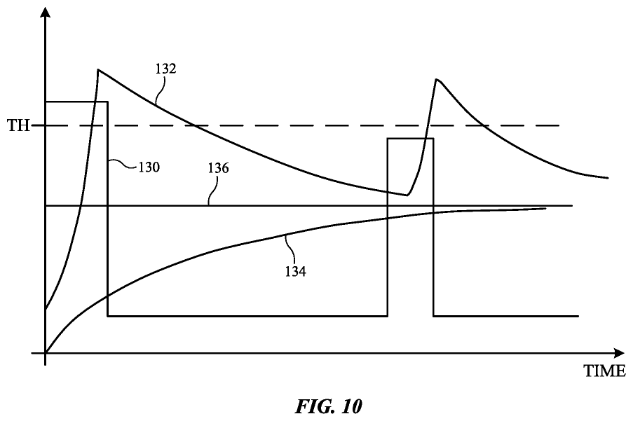

FIG. 10 is a plot showing how a UE device 10 may optimize performance by proactively requesting optimal network configuration C*. Curve 130 plots the wireless data throughput of UE device 10 and curve 132 plots the temperature of device 10 (which is directly proportional to power consumption) in implementations where UE device 10 performs reactive adjustments to network configuration rather than proactive requests for optimal network configuration C*.

As shown by curve 130, UE device 10 initially exhibits high throughput under a given network configuration. However, this high throughput may cause device temperature to peak relatively quickly. Once device temperature passes threshold TH, the UE device reactively adjusts the network configuration to mitigate temperature (e.g., by degrading the network configuration and/or temporarily stopping wireless data transfer). This causes throughput to drop. Once the drop in throughput brings device temperature back down below threshold TH for a predetermined time period (e.g., once the thermal condition has been mitigated), UE device 10 reactively adjusts the network configuration to boost wireless performance (e.g., by upgrading the network configuration and/or resuming wireless data transfer). This causes throughput to rise again, which causes temperature to spike above threshold TH. This cycle may continue over time as the UE device reactively enters and exits a thermal condition or trap. As shown by curve 130, such reactive adjustment causes data throughput to be undesirably bursty, which can disrupt wireless data transfer and user experience.

On the other hand, curve 136 plots the wireless data throughput of UE device 10 and curve 134 plots the temperature of device 10 in implementations where UE device 10 performs proactive requests for optimal network configuration C* (e.g., using the operations of FIGS. 7 and 8). As shown by curve 134, by first selecting and implementing optimal network configuration C* and then conveying wireless data using the optimal network configuration C*, power consumption and thus device temperature may slowly increase but remains consistently below threshold TH (e.g., because UE device 10 selected an optimal network configuration that would not otherwise cause temperature to rise above threshold TH given the current UE contextual information). This allows UE device 10 to maintain a consistent data throughput over time, as shown by curve 136, rather than requiring bursty wireless communications. This may serve to minimize wireless data transfer disruptions and optimizes user experience. The example of FIG. 10 is merely illustrative and, in practice, curves 130-136 may have other shapes.

UE device 10 and/or network 22 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-10 may be performed by the components of UE device 10, base station(s) 12, and/or network 22 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 30 of FIG. 2). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry 32 of FIG. 2, etc.). The processing circuitry may include microprocessors, central processing units (CPUs), application-specific integrated circuits with processing circuitry, or other processing circuitry.

If desired, an apparatus may be provided that includes means to perform one or more elements or any combination of elements of one or more methods or processes described herein.

If desired, one or more non-transitory computer-readable media may be provided that include instructions to cause an electronic device, upon execution of the instructions by one or more processors of the electronic device, to perform one or more elements or any combination of elements of one or more methods or processes described herein.

If desired, an apparatus may be provided that includes logic, modules, or circuitry to perform one or more elements or any combination of elements of one or more methods or processes described herein.

If desired, an apparatus may be provided that includes one or more processors and one or more non-transitory computer-readable storage media comprising instructions that, when executed by the one or more processors, cause the one or more processors to perform one or more elements or any combination of elements of one or more methods or processes described herein.

If desired, a signal (e.g., a signal encoded with data), datagram, information element (IE), packet, frame, segment, PDU, or message may be provided that includes or performs one or more elements or any combination of elements of one or more methods or processes described herein.

If desired, an electromagnetic signal may be provided that carries computer-readable instructions, where execution of the computer-readable instructions by one or more processors causes the one or more processors to perform one or more elements or any combination of elements of one or more methods or processes described herein.

If desired, a computer program may be provided that includes instructions, where execution of the program by a processing element causes the processing element to carry out one or more elements or any combination of elements of one or more methods or processes described herein.

The foregoing is merely illustrative and various modifications can be made to the described embodiments. The foregoing embodiments may be implemented individually or in any combination.

What is claimed is:

1. A method of operating a user equipment device, the method comprising:
receiving, at a receiver, network configuration data aggregated from a set of additional user equipment devices; and
transmitting, using one or more antennas, a request to a wireless base station to perform wireless communications using a network configuration that is selected based on the network configuration data aggregated from the set of additional devices.

2. The method of claim 1, wherein the network configuration comprises an entry of the network configuration data that is selected from the network configuration data based on contextual information associated with operation of the user equipment device.

3. The method of claim 2, wherein the contextual information comprises:
an application usage type associated with an application that is executed by the or more processors and that requires the wireless communications.

4. The method of claim 2, wherein the contextual information comprises:
a battery state of the user equipment device.

5. The method of claim 2, wherein the contextual information comprises a location of the electronic device.

6. The method of claim 1, wherein receiving the network configuration data comprises receiving the network configuration data from a server that aggregates the network configuration data from the set of additional user equipment devices.

7. The method of claim 5, further comprising:
transmitting, using a transmitter, a request to the server for the network configuration data based on contextual information associated with operation of the user equipment device.

8. The method of claim 7, wherein the request comprises a request for entries of a network configuration database stored on the server, the entries corresponding to a network operator and a location identified by the contextual information.

9. The method of claim 7, wherein the request comprises a request for entries of a network configuration database stored on the server, the entries corresponding to a set of geographic tiles identified by the contextual information.

10. The method of claim 9, wherein the set of geographic tiles comprise geographic tiles neighboring a location of the user equipment device.

11. The method of claim 9, wherein the set of geographic tiles comprise geographic tiles overlapping and neighboring a predicted future location of the user equipment device.

12. The method of claim 9, wherein the geographic tiles comprise geographic tiles along a navigation route for the user equipment device set by a navigation application executed by one or more processors on the user equipment device.

13. The method of claim 6, wherein the network configuration data comprises a set of table entries each corresponding to a respective combination of location and network operator.

14. The method of claim 13, wherein each table entry in the set of table entries identifies a respective set of radio resource control (RRC), data radio bearer (DRB), and physical layer configurations.

15. The method of claim 1, wherein the request comprises radio resource control (RRC) user assistance information (UAI) identifying one or more settings of the network configuration.

16. The method of claim 15, further comprising:
receiving, using the one or more antennas, an RRC response to the request from the wireless base station.

17. A method of operating a server, the method comprising:
receiving, at a receiver, contextual information from a set of user equipment devices, the contextual information identifying locations and application data transmission patterns of the user equipment devices in the set of user equipment devices;
aggregating, using one or more processors, the contextual information into entries of a data structure, each entry of the data structure identifying a network configuration exhibiting peak aggregate wireless performance for a different respective combination of the locations and the application data transmission patterns;
receiving, at the receiver, a request from a given user equipment device for a set of entries from the data structure; and
transmitting, using a transmitter, the set of entries from the data structure to the given user equipment device.

18. The method of claim 17, wherein the request from the given user equipment identifies a set of geographic tiles and the set of entries from the data structure includes entries from the data structure corresponding to the set of geographic tiles.

19. The method of claim 17, further comprising:
transmitting, using the transmitter, a table to the given user equipment device that maps different applications to the application data transmission patterns.

20. An electronic device comprising:
one or more processors configured to execute an application that requires conveying wireless data;
a radio configured to convey the wireless data at a geographic location using a set of different network configurations, the radio being further configured to gather wireless performance metric data associated with the wireless data conveyed by the radio; and
one or more antennas configured to
transmit a radio resource control (RRC) signal to a wireless base station, the RRC signal including a user equipment assistance information (UAI) message identifying a network configuration that is selected from the set of different network configurations based on the wireless performance metric data, and
convey the wireless data with the wireless base station using the identified network configuration while the electronic device is at the geographic location.
